(19) United States
(12) Patent Application Publication
(10) Pub. No.: US 2005/0008269 A1
(43) Pub. Date: Jan. 13, 2005

(54) Hydrostatic bearing, alignment apparatus, exposure apparatus, and device manufacturing method

(75) Inventors: Kotaro Akutsu, Saitama (JP); Choshoku Sai, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/876,540

(22) Filed: Jun. 28, 2004

(30) Foreign Application Priority Data
Jul. 8, 2003 (JP) 2003-193634 (PAT.

(51) Int. Cl. F16C 32/06; F01L 1/18

(52) U.S. Cl. 384/12

(57) ABSTRACT

A bearing surface (50) opposing a movable guide (21) of a hydrostatic bearing has a gas supply hole (52) which has an orifice with a diameter smaller than that of the outer shape of the bearing. Each of hydrostatic bearings (14, 24) incorporates a poppet valve (53) which can seamlessly change the flow resistance in the gas supply hole (52), an actuator unit (55) for linearly driving the poppet valve (53), and a guide mechanism (58) which guides the poppet valve (53) so as to set the poppet valve (53) in linear motion. The actuator unit (55) has, for example, coils (56) arranged on the movable side (the base of the poppet valve (53)) and permanent magnets arranged on the fixed side (a portion opposing the base of the poppet valve (53)). With this arrangement, the poppet valve (53) can be driven at high speed and high precision. The poppet valve (53) is driven in accordance with a command from a controller (51). A pressure (Ps) is applied to the poppet valve (53) as the back pressure. The pressure (Ps) is restricted by the poppet valve (53) and a bearing clearance and becomes a bearing mean pressure (p).

### FIELD OF THE INVENTION

The present invention relates to an alignment apparatus which moves and aligns a substrate such as a wafer or an original such as a reticle at high speed and high precision in, for example, various measuring instruments or processing machines, a projection exposure apparatus for use in a semiconductor lithography process, or the like and, more particularly, to an alignment apparatus suitable for use in a vacuum atmosphere.

### BACKGROUND OF THE INVENTION

FIG. 13 shows the arrangement of a conventional alignment apparatus using a hydrostatic pressure bearing pad which moves and aligns a substrate such as a wafer (e.g., see Japanese Patent Laid-Open No. 62-24929). Reference numeral 240 denotes a fixed base 240; and 242x and 242y, X fixed guides and Y fixed guides which extend and are fixedly provided in the X and Y directions. Reference numerals 230x and 230y denote an X movable guide and Y movable guide which intersect each other and are arranged in a two-level manner so as to move along the X fixed guides 242x and Y fixed guides 242y. The fixed guides 242x and 242y serving as stators and the movable guides 230x and 230y serving as movable elements constitute linear motors which can drive in the X and Y directions. Each of the movable guides 230x and 230y receives the driving force of the corresponding linear motor and smoothly moves in one axial direction. An X-Y stage 220 is arranged at a portion where the X movable guide 230x and Y movable guide 230y intersect each other. The X-Y stage 220 can be aligned within the X-Y plane when the driving force in the X direction from the X movable guide 230x and the driving force in the Y direction from the Y movable guide 230y are transmitted to the X-Y stage 220 through a restraint hydrostatic bearing 214. A compressed fluid such as a compressed gas (e.g., air) is supplied from a supply pressure control means 250 to the restraint hydrostatic bearing.

However, in supply pressure control for the hydrostatic bearings in the conventional technique, the following problem remains unsolved. More specifically,

Let m be the mass of the X-Y stage serving as a moving member, and α be the acceleration. In driving, a dynamic load f=mα is applied to the restraint hydrostatic bearing. To whatever extent a rigidity k of the restraint hydrostatic bearing is increased, a dynamic clearance variation δ in f=kδ occurs. Consequently, a little clearance of the hydrostatic bearing cannot be ensured. At whatever high speed the supply pressure of the fluid is controlled, there is a large amount of gas including some in hoses on the supply side, and the pressure in the bearing does not respond at high speed due to the compressibility of the gas. For this reason, it is difficult to increase the controllability.

### SUMMARY OF THE INVENTION

The present invention has been made in consideration of the above-mentioned problems, and has as its object to provide a technique which can reduce to substantially zero the dynamic clearance variation of a hydrostatic bearing generated upon movement of a moving member.

To solve the above-mentioned problems and achieve the object, the aspects of the present invention will be listed below.

[First Aspect]

According to the first aspect, there is provided an alignment apparatus comprising bearing means for neutrally levitating a structure by a fluid having a predetermined pressure, control means for controlling the pressure of the fluid for axially supporting the structure, and driving means for moving and aligning the structure to a target position, wherein the control means controls the pressure of the fluid so as to cancel any displacement generated in the bearing means upon movement of the structure.

[Second Aspect]

The alignment apparatus according to the first aspect is wherein the bearing means comprises first and second bearing means juxtaposed to each other, and the control means controls the pressure of the fluid so as to cancel any displacement generated in the second bearing means upon movement of the structure.

[Third Aspect]

The alignment apparatus according to the first or second aspect is wherein the control means comprises restriction means for giving a resistance to a flow of the fluid and making variable the pressure of the fluid ejected from the bearing means.

[Fourth Aspect]

The alignment apparatus according to any one of the first to third aspects is wherein the restriction means comprises a valve that restricts an inlet of a hole through which the fluid passes, and the control means changes a channel area of the fluid by controlling a position of the valve and controls the pressure of the fluid.

[Fifth Aspect]

The alignment apparatus according to any one of the first to third aspects is wherein the restriction means comprises a shutter that restricts in a noncontact manner an inlet of a hole through which the fluid passes, and the control means changes a restriction amount of the fluid by controlling a position of the shutter and controls the pressure of the fluid.

[Sixth Aspect]

The alignment apparatus according to the fifth aspect is wherein a bimorph actuator is used as a driving source of the shutter.

[Seventh Aspect]

The alignment apparatus according to the fifth aspect is wherein an actuator which has an electromagnet is used as a driving source of the shutter.

[Eighth Aspect]

The alignment apparatus according to the fifth aspect is wherein a supermagnetostrictor actuator is used as a driving source of the shutter.

[Ninth Aspect]

The alignment apparatus according to the fifth aspect is wherein the shutter comprises means for amplifying a displacement of the shutter.

[10th Aspect]

The alignment apparatus according to any one of the first to ninth aspects is wherein the driving means moves the structure with a predetermined driving force.

[11th Aspect]

The alignment apparatus according to the 10th aspect is wherein the predetermined driving force is feed-forwarded to the control means.

[12th Aspect]

The alignment apparatus according to any one of the first to ninth aspects is wherein the bearing means supports the structure on a surface substantially perpendicular to a moving direction of the structure.

[13th Aspect]

The alignment apparatus according to any one of the second to 12th aspects is wherein the control means reduces to substantially zero the pressure of the fluid for the second bearing means if no displacement is generated.

[14th Aspect]

The alignment apparatus according to any one of the first to 13th aspects is wherein the alignment apparatus is arranged in a chamber whose interior is kept in a vacuum atmosphere, and the alignment apparatus further comprises exhausting means for exhausting the fluid so as to prevent the fluid ejected from the bearing means from flowing into the chamber.

[15th Aspect]

An exposure apparatus is comprising an alignment apparatus according to any one of the first to 14th aspects, wherein the exposure apparatus aligns at least one of a substrate and original by the alignment apparatus.

[16th Aspect]

A processing apparatus is comprising an alignment apparatus according to any one of the first to 14th aspects, wherein the processing apparatus machines an object by the alignment apparatus.

[17th Aspect]

A device manufacturing method is comprising a step of performing exposure using an exposure apparatus according to the 15th aspect.

[18th Aspect]

According to the 18th aspect, there is provided a hydrostatic bearing which neutrally levitates a structure by a fluid having a predetermined pressure and axially supports the structure in a noncontact manner, comprising variable means for making variable the pressure of the fluid for axially supporting the structure, and control means for controlling the pressure of the fluid by the variable means.

As has been described above, according to the present invention, the internal pressure of a hydrostatic bearing can be controlled at high speed. This makes it possible to cancel a displacement generated in the hydrostatic bearing upon movement of a structure and reduces to substantially zero the dynamic clearance variation of the hydrostatic bearing.

Other objects and advantages besides those discussed above shall be apparent to those skilled in the art from the description of a preferred embodiment of the invention, which follows. In the description, reference is made to accompanying drawings, which form apart thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a perspective view showing an arrangement example of an alignment apparatus according to the first embodiment of the present invention;

FIG. 2 is a sectional view showing the detailed arrangement of hydrostatic bearings mounted on the alignment apparatus according to the first embodiment;

FIGS. 3A and 3B are views for explaining load on the hydrostatic bearings;

FIGS. 4A to 4D are timing charts showing the bearing clearance variation of each hydrostatic bearing when the hydrostatic bearing receives load;

FIG. 5 is a sectional view showing the detailed arrangement of hydrostatic bearings mounted on an alignment apparatus according to the second embodiment;

FIG. 6 is a perspective view showing an arrangement according to the third embodiment in which an alignment apparatus is used in a vacuum atmosphere;

FIG. 7 is a sectional view showing the arrangement according to the third embodiment in which the alignment apparatus is used in the vacuum atmosphere;

FIGS. 8A to 8C show the detailed arrangement of hydrostatic bearings according to the fourth embodiment and are a view as seen from the X-Z plane, a sectional view taken along the X-Y plane, and a graph showing the pressure distribution in a bearing clearance h, respectively;

FIGS. 9A and 9B are views showing an arrangement example of each hydrostatic bearing when a bimorph actuator is used as the actuator unit of a shutter 65;

FIG. 10 is a view showing an arrangement example in which an electromagnet is used as the actuator unit;

FIG. 11 is a view showing an arrangement example of the shutter which uses a displacement amplifying mechanism 80;

FIG. 12 is a view showing an exposure apparatus on which an alignment apparatus is mounted according to the fourth embodiment;

FIG. 13 is a perspective view showing an arrangement example of a conventional alignment apparatus;

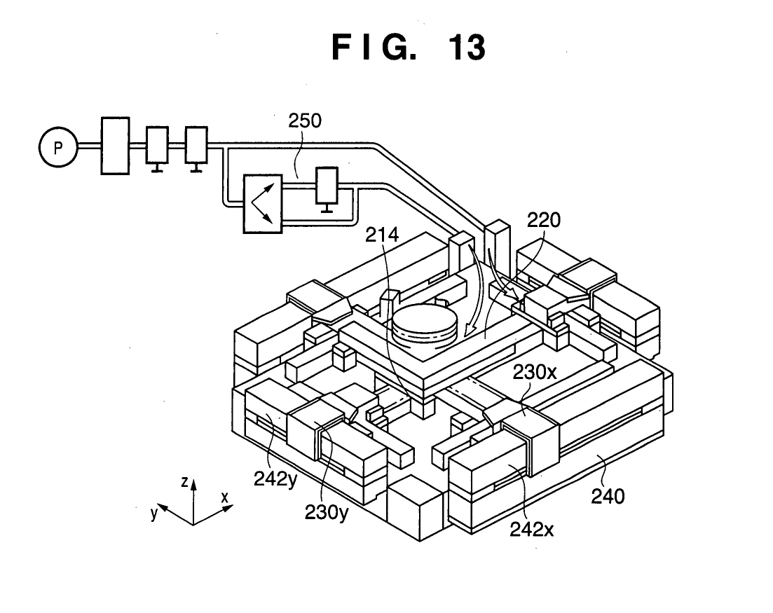

FIG. 14 is a flow chart for explaining the flow of the manufacture of a semiconductor device; and

FIG. 15 is a flow chart for explaining the wafer process.

### DETAILED DESCRIPTION OF THE PREFERRED EMBODIMENTS

Embodiments of the present invention will be described in detail with reference to the accompanying drawings.

[First Embodiment]

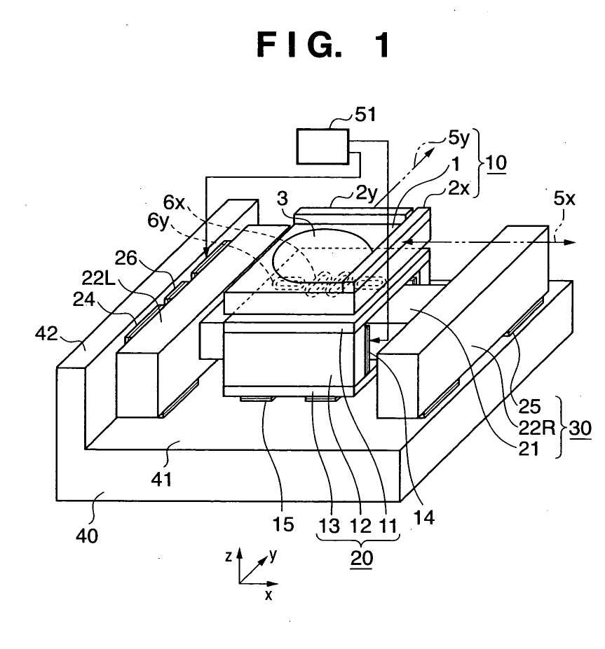

FIG. 1 shows an arrangement example of an alignment apparatus according to the first embodiment of the present invention. An alignment apparatus to be illustrated in this embodiment is mounted on various measuring instruments or processing machines, a projection exposure apparatus for use in a semiconductor lithography process, or the like. The alignment apparatus moves and aligns a substrate such as a wafer or an original such as a reticle at high speed and high precision.

The alignment apparatus comprises a wafer stage 10, X stage 20, Y stage 30, and fixed base 40. The wafer stage 10 also has a wafer 3, X-Y position measurement mirrors 2x and 2y, and a top plate 1 which holds them. The X-Y position measurement mirrors 2x and 2y have respective reflection surfaces which are irradiated with laser beams 5x and 5y. Measuring the laser beams reflected by the reflection surfaces using interferometers makes it possible to accurately measure an X-Y distance variation of the top plate 1 from a certain reference. The relative distance between the wafer 3 and the X-Y position measurement mirrors 2x and 2y held by the top plate 1 should vary in no case. Accordingly, a material having high rigidity and a small coefficient of linear expansion is desirable for the top plate 1. For example, a ceramic material made of, for example, SiC is desirably employed.

The X stage 20 comprises an X top plate 11, X side plates 12, and an X bottom plate 13. Aluminum, which is inexpensive and lightweight, can be used as a material for the structure.

Referring to FIG. 1, the wafer stage 10 is mounted on the X top plate 11 of the X stage 20 through a support means as disclosed in Japanese Patent Laid-Open No. 7-111238. By controlling linear motors 6x and 6y, driving forces are applied to the wafer stage 10 in the X direction, Y direction, and rotational direction about the Z-axis. The wafer stage 10 is aligned in the X direction, Y direction, and rotational direction about the Z-axis, on the basis of measurement results (output signals) from the laser interferometers. With the linear motors 6x and 6y, the behavior of the X stage 20 in the X and Y directions is not transmitted to the wafer stage 10. Accordingly, hydrostatic pressure bearings used in the X stage 20 and Y stage 30 only need to bear load. Each hydrostatic bearing may have lower rigidity and damping performance than a conventional one.

The Y stage 30 comprises a movable guide 21 which has guide surfaces on its sides and Y sliders 22R and 22L. A material such as aluminum can be used for the structure as well.

The fixed base 40 comprises a Z guide 41 which supports the lower surfaces of the stages and a yaw guide 42 which supports the Y stage in the X direction.

The Y stage 30 is supported in the X direction by the yaw guide 42 through Y side (lateral) hydrostatic bearings 24 each having an instantaneous pressure increase/decrease function and is supported in the Z direction by the Z guide 41 through Y bottom (vertical) hydrostatic bearings 25. With this arrangement, the Y stage 30 can smoothly move in the Y direction. The X stage 20 is supported in the Y direction by the movable guide 21 through X side hydrostatic bearings 14 each having an instantaneous pressure increase/decrease function and is supported in the Z direction by the Z guide 41 through X bottom hydrostatic bearings 15. The X stage 20 can smoothly move in the X direction along the movable guide 21 and in the Y direction together with the Y stage 30. The Y side hydrostatic bearings 24, which are formed as hydrostatic bearing pads, are fixed on a side of the Y slider 22L, and the Y bottom hydrostatic bearings 25 are fixed on the lower surfaces of the Y sliders 22R and 22L. Similarly, the X side hydrostatic bearings 14 are fixed on the X side plates 12, and the X bottom hydrostatic bearings 15 are fixed on the lower surface of the X bottom plate 13.

The X side hydrostatic bearings 14 have a restraint structure which sandwiches the movable guide 21. The Y side hydrostatic bearings 24 have in juxtaposition with them a prestress means 26 such as a permanent magnet which generates an attraction force and have a simple levitated structure.

In other words, the X side hydrostatic bearings 14 and Y side hydrostatic bearings 24 support the X stage 20 and Y stage 30 serving as structures, respectively, on surfaces substantially perpendicular to the moving directions of the structures.

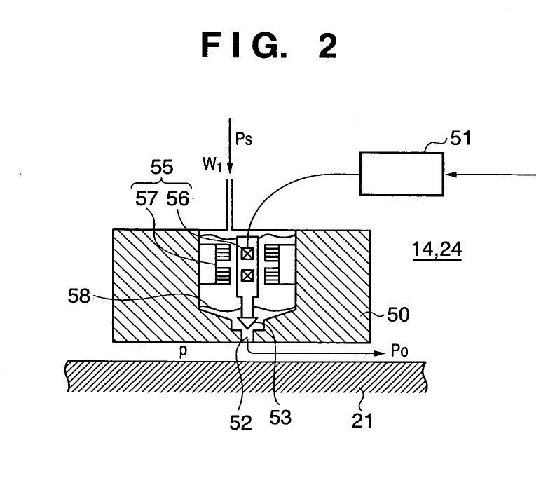

FIG. 2 is a sectional view, taken along the X-Y plane, showing the detailed arrangement of the X and Y side hydrostatic bearings 14 and 24 which are mounted on the alignment apparatus according to this embodiment and have the instantaneous pressure increase/decrease functions.

Each hydrostatic bearing in this embodiment uses a variable restriction mechanism to implement an instantaneous pressure increase/decrease function. A gas supply hole 52 which has an orifice with a diameter smaller than that of the outer shape of the bearing is formed in a bearing surface 50 which opposes the movable guide 21. Each of the hydrostatic bearings 14 and 24A incorporates a poppet valve 53 which can seamlessly change the flow resistance in the gas supply hole 52, an actuator unit 55 for linearly driving the poppet valve 53, and a guide mechanism 58 which guides the poppet valve 53 so as to set the poppet valve 53 in linear motion. The actuator unit 55 has, for example, coils 56 arranged on the movable side (the base of the poppet valve 53) and permanent magnets arranged on the fixed side (a portion opposing the base of the poppet valve 53). With this arrangement, the actuator unit 55 can drive the poppet valve 53 at high speed and high precision. The poppet valve 53 is driven in accordance with a command from a controller 51. A pressure Ps is applied to the poppet valve 53 as the back pressure. The pressure Ps is reduced by the poppet valve 53 and a bearing clearance and becomes a bearing mean pressure p.

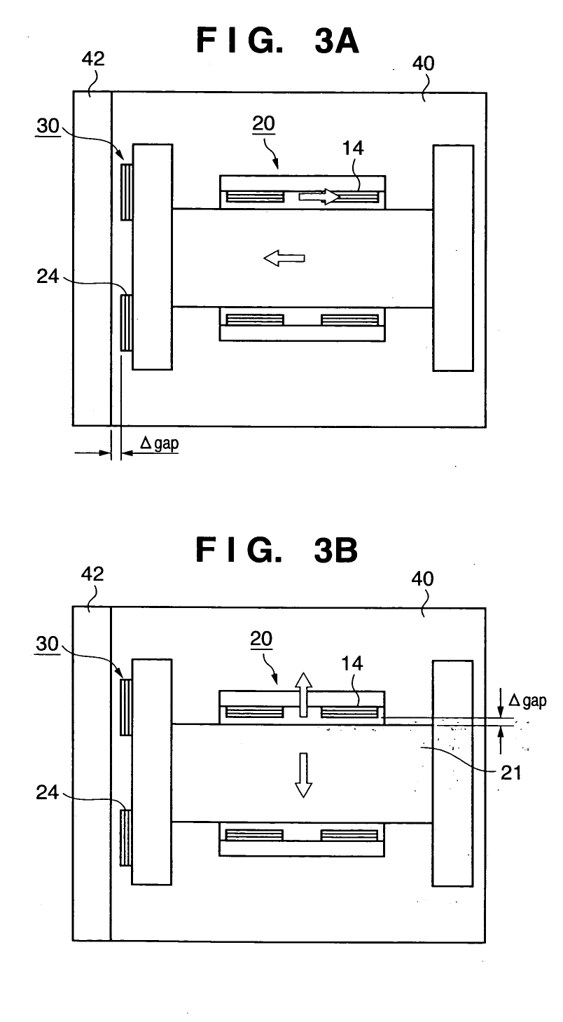

How the hydrostatic bearings receive load will be described with reference to FIGS. 3A and 3B.

First, a case will be described with reference to FIG. 3A wherein the wafer stage 10 is driven in the X direction. In driving in the X direction, the reaction force of a driving force fx corresponding to the product of a driving acceleration and the total mass of the wafer stage 10 and X stage 20 is generated in the Y stage 30. The reaction force acts on the Y side hydrostatic bearings 24 as load. At this time, the Y side hydrostatic bearings 24 desirably have a sufficient margin to the driving force fx.

Then, a case will be described with reference to FIG. 3B wherein the wafer stage 10 is driven in the Y direction. In driving in the Y direction, a driving force fy corresponding to the product of the driving acceleration and the total mass of the wafer stage 10 and X stage 20 is applied to the X side hydrostatic bearings 14 as load. At this time, the X side hydrostatic bearings 14 desirably have sufficiently high resistance to the driving force fy.

A large translational force as described above does not act on each of the Y bottom hydrostatic bearings 25 and X bottom hydrostatic bearings 15. A moment force corresponding to the product of a driving force and the stage barycenter may act instead. Load on each hydrostatic bearing is expected to be smaller than that in the above-mentioned cases.

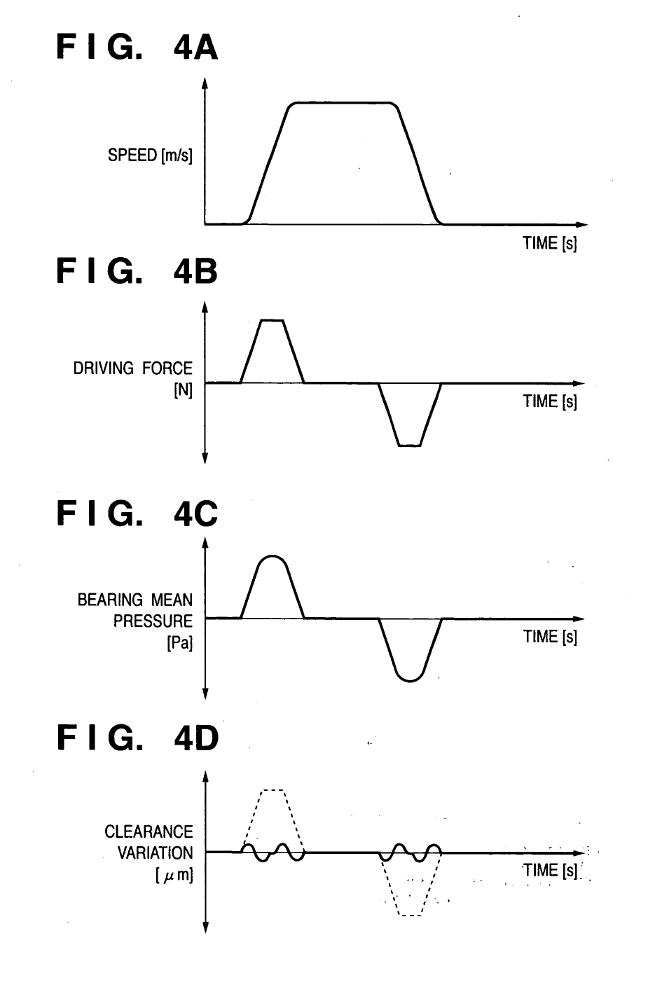

Controlling to drive the poppet valve 53 can change the bearing mean pressure p without changing the back pressure Ps and bearing clearance. This will be described with reference to the timing charts in FIGS. 4A to 4D.

When the wafer stage is driven in the Y direction, the waveform of its speed and the waveform of a required driving force are shown in FIGS. 4A and 4B, respectively. In a general hydrostatic bearing or a hydrostatic bearing which performs back pressure control as shown in the conventional example, a clearance greatly varies as indicated by a broken line in FIG. 4D. In each X side hydrostatic bearing 14 according to the first embodiment of the present invention, if load acts in a direction which reduces a corresponding bearing clearance, the poppet valve 53 is driven in a direction which enlarges the gas supply hole 52. With this operation, the bearing mean pressure p increases. On the other hand, if load acts in a direction which increases the bearing clearance, the poppet valve 53 is driven in a direction which reduces the gas supply hole 52. With this operation, the bearing mean pressure p decreases. As a result, the bearing clearance hardly changes as indicated by a solid line in FIG. 4D.

To provide for contact with a guide, a self-lubricating material such as carbon can be used for the bearing surface 50.

The X stage 20 and Y stage 30 serving as the structures are desirably driven by feed-forwarding a predetermined driving force to a control means.

[Second Embodiment]

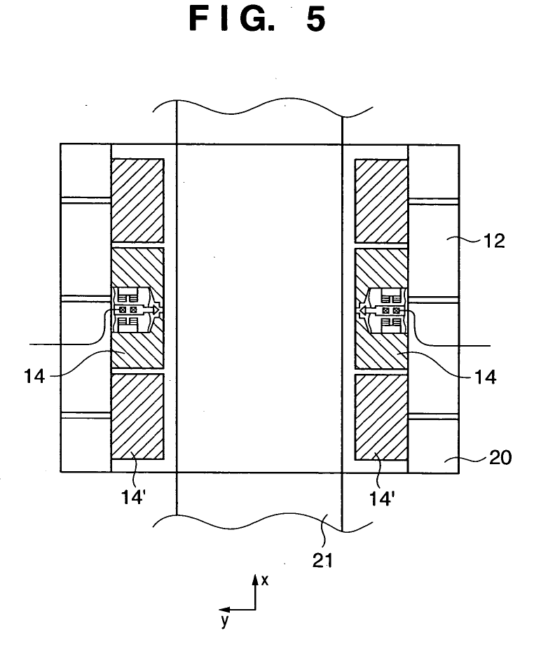

FIG. 5 is a sectional view, taken along the X-Y plane, showing the detailed arrangement of X side hydrostatic bearings according to the second embodiment.

In the first embodiment, each hydrostatic bearing having an instantaneous pressure increase/decrease function operates constantly. However, conventional hydrostatic bearings 14′ which operate constantly and hydrostatic bearings 14 (24) having instantaneous pressure increase/decrease functions can be juxtaposed to each other, as shown in FIG. 5. When a driving force does not act on an X stage 20 serving as a movable member (when the X stage 20 is in a stationary state or when the X stage 20 is moving at a constant speed), the internal pressure of the hydrostatic bearings 14 (24) having the instantaneous pressure increase/decrease functions is reduced to substantially zero, and the X stage 20 is supported by only the conventional hydrostatic bearings 14′. Only when a driving force acts, the hydrostatic bearings 14 (24) having the instantaneous pressure increase/decrease functions are made to act in turn.

With this arrangement, if porous restrictions are used for the conventional hydrostatic bearings 14′, the flow rate required for the apparatus can be reduced.

[Third Embodiment]

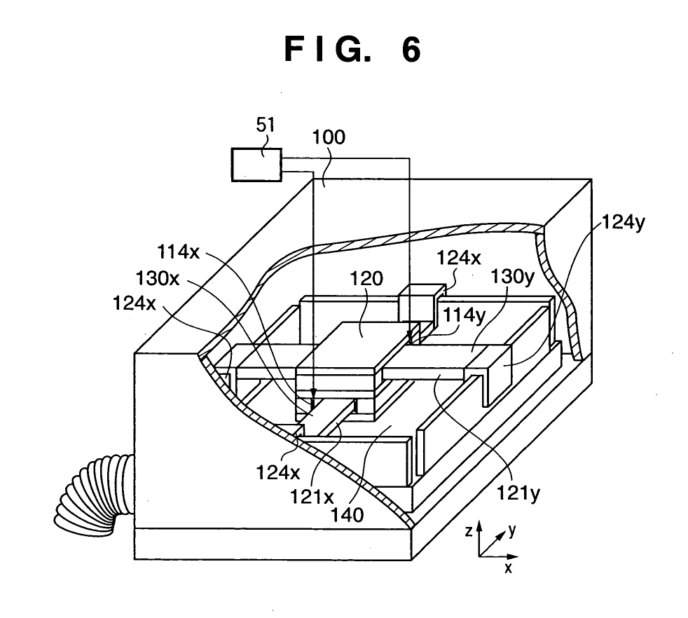

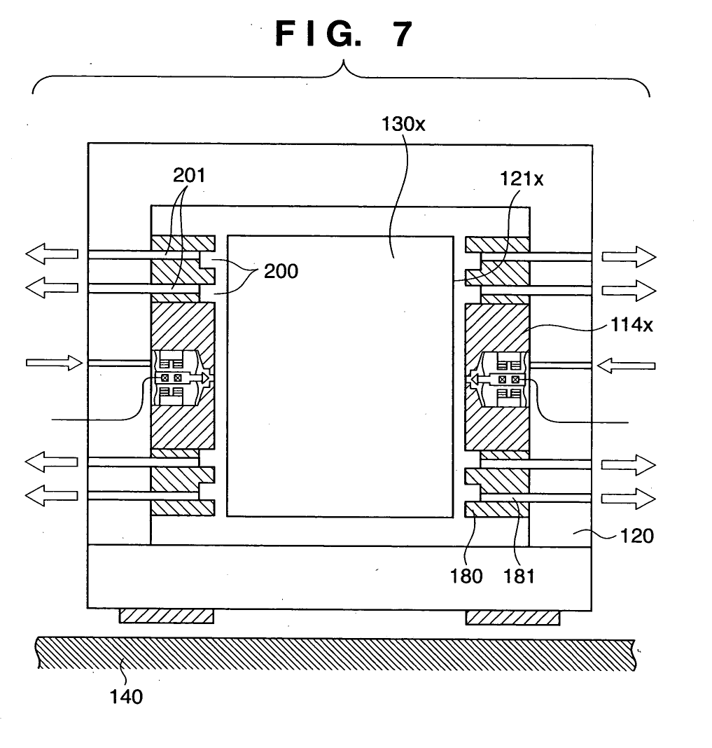

A case will be described with reference to FIGS. 6 and 7 wherein an alignment apparatus according to this embodiment is used in a vacuum atmosphere. FIG. 6 shows the case wherein the alignment apparatus is used in the vacuum atmosphere. Also, in FIG. 6, a stage different from that in the first embodiment is shown.

The stage serving as the alignment apparatus is arranged in a chamber 100 whose interior is kept in a vacuum state. The stage comprises a center slider 120 which can move in the X-Y plane, an X slider 130x which can move only in the X direction, and a Y slider 130y which can move only in the Y direction. The X slider 130x is supported in the Y and Z directions by a pair of hydrostatic bearings 124x. The Y slider 130y is supported in the X and Z directions by a pair of hydrostatic bearings 124y. The center slider 120 is supported with respect to the X slider 130x and Y slider side surfaces 121x and 121y through hydrostatic bearings 114x and 114y. In this arrangement, a driving force generated when the center slider 120 is moved in the X or Y direction largely acts on the hydrostatic bearings 114x and 114y. Almost no driving force is generated in the hydrostatic bearings 124x and 124y, which supports the X slider 130x and Y slider 130y. For this reason, the only hydrostatic bearings 114x and 114y have instantaneous pressure increase/decrease bearings. Measures to keep the vacuum state can be implemented by providing labyrinth mechanisms 180 with grooves and gas exhaust holes 181 in the vicinity of both sides of the hydrostatic bearing 114x which extend from the grooves to the outside, as shown in FIG. 7, and exhausting a fluid. A compressed fluid ejected from the hydrostatic bearing 114x is exhausted through the labyrinth mechanisms 180 and gas exhaust holes 181. The fluid does not leak to the outside (the interior of the chamber 100).

[Fourth Embodiment]

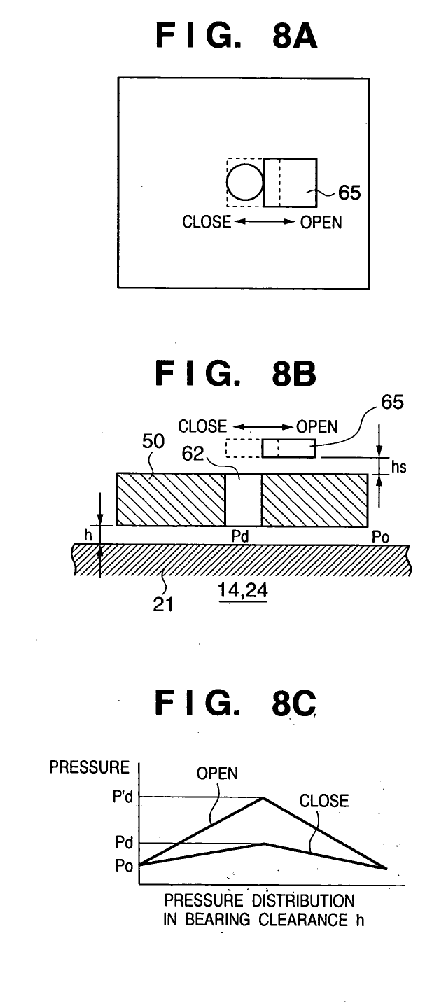

FIGS. 8A to 8C show the detailed arrangement of an X side hydrostatic bearing according to the fourth embodiment and are a view as seen from the X-Z plane, a sectional view taken along the X-Y plane, and a graph showing the pressure distribution in a bearing clearance h, respectively.

The fourth embodiment is the same as the above-mentioned embodiments in that X side hydrostatic bearings 14 have a restraint structure which sandwich a movable guide 21. Y side hydrostatic bearings 24 have in juxtaposition with them a prestress means 26 such as a permanent magnet which generates an attraction force and has a simple levitated structure. The fourth embodiment is different from the above-mentioned embodiment in that a function of instantaneously increasing/decreasing a pressure is implemented using a noncontact variable restriction mechanism.

A shutter 65 which can continuously change the flow resistance in a gas supply hole 62 and an actuator unit (not shown) for driving the shutter 65 are provided in each of the X side hydrostatic bearings 14 and Y side hydrostatic bearings 24.

FIG. 8C shows the pressure distribution in a bearing clearance h when the shutter 65 is opened or closed. When the shutter 65 is closed, a compressed fluid passes through a shutter clearance hs and flows to the gas supply hole 62. The fluid flows from the gas supply hole 62 to the bearing clearance h and is discharged from the bearing clearance h into an ambient atmosphere. On the other hand, when the shutter 65 is opened, the compressed fluid directly flows to the shutter 65 and passes through the gas supply hole 62. The fluid flows into the bearing clearance h and is discharged into the ambient atmosphere. A bearing load capacity is obtained by integrating the pressure distribution within the bearing clearance h with respect to the bearing area. As can be seen from the above description, in the mechanism shown in FIGS. 8A to 8C, the bearing load capacity can seamlessly be changed by changing the opening degree of the shutter 65.

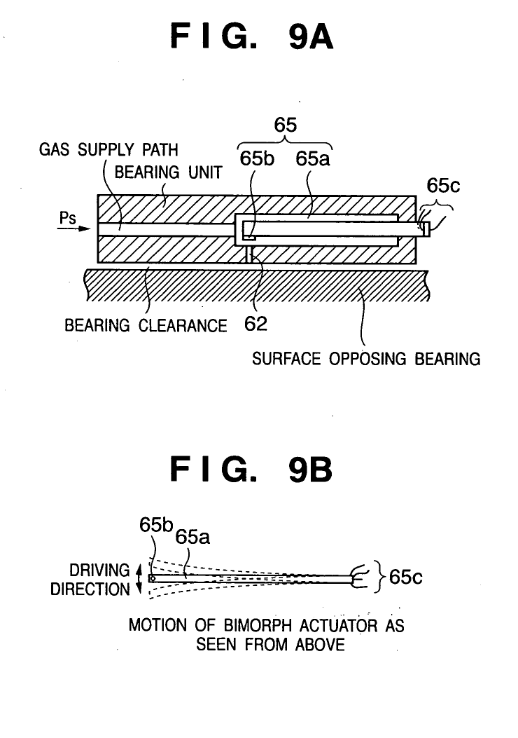

FIGS. 9A and 9B are views showing an arrangement example of the hydrostatic bearing when a bimorph actuator is used as the actuator unit of a shutter 65. As shown in FIG. 9A, a chip 65b is attached to the leading end of a bimorph actuator 65a, and the chip 65b and the gas supply hole 62 in the bearing immediately below the shutter 65 keep a small interval. The small interval is preferably so kept as to fall within the range from 1 to 50 μm. Assume that the interval is increased excessively. In this case, even if the shutter 65 comprising the bimorph actuator 65a and chip 65b is opened or closed, the pressure in the bearing clearance hardly change or does not change upon a change in flow rate.

FIG. 9B shows how the distal end (chip portion 65b) moves when the bimorph actuator 65a is driven. By applying an appropriate voltage to the lead line 65c of the bimorph actuator 65a, the distal end (chip portion 65b) swings in a manner indicated by an arrow in FIG. 9B. With this swing, the flow of a compressed fluid into the gas supply hole 62 immediately below can or cannot be controlled.

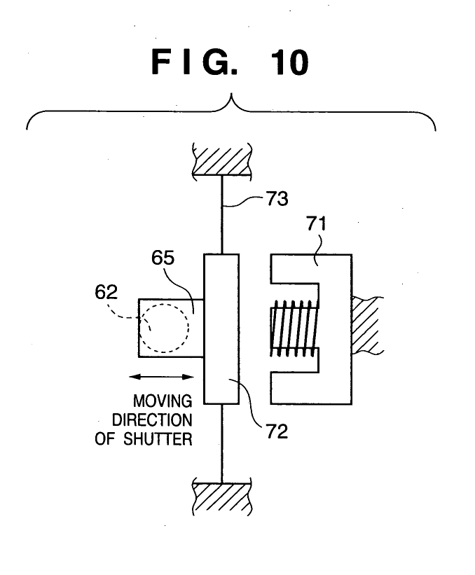

FIG. 10 is a view showing an arrangement example in which an electromagnet is used as the actuator unit. An attraction surface 72 of an electromagnet 71 is supported by a flexible leaf spring 73, and the shutter 65 which controls the compressed fluid into the bearing gas supply hole 62 is arranged. By controlling a current to be supplied to the electromagnet 71, the shutter 65 can be moved in a direction indicated by an arrow in FIG. 10, and the flow rate to the gas supply hole 62 can be controlled.

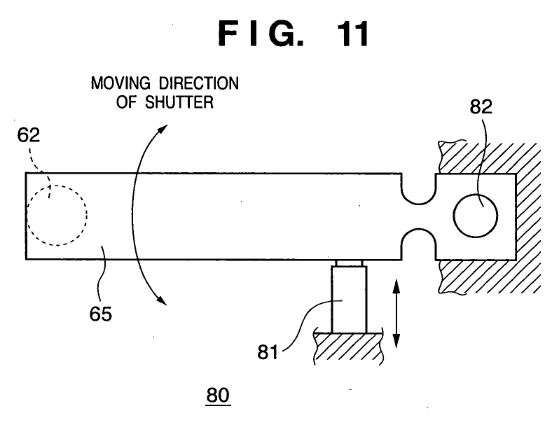

FIG. 11 shows an arrangement example of the shutter which uses a displacement amplifying mechanism 80. A cantilever which constitutes the shutter 65 has one end fixed in a fixing hole 82 and the other end (the leftmost in FIG. 11) is arranged immediately above the gas supply hole 62. An actuator unit 81 is arranged closer to the fixed end. A small displacement generated by driving the actuator unit 81 is amplified and enlarged at the left end of FIG. 11, thereby obtaining a desired moving amount. The actuator unit 81 may be a piezoelectric actuator or supermagnetostriction actuator.

The examples shown in FIGS. 9A and 9B to 11 are merely examples using the principle of a noncontact variable restriction. The present invention is not limited to any one of the arrangements shown in FIGS. 9A and 9B to 11. Even when a plurality of gas supply holes are present in a bearing surface, the principle of variable restriction shown in FIGS. 8A to 8C is preferably applied to each gas supply hole.

By driving the noncontact variable restriction, a bearing clearance variation can be suppressed, similarly to the first embodiment described with reference to FIG. 4A to 4D.

Also, like the second embodiment shown in FIG. 5, the conventional hydrostatic bearings 14′ which are constantly operating and the hydrostatic bearings 14 (24) with instantaneous pressure increase/decrease functions can be juxtaposed to each other. Use of a porous restriction as the conventional hydrostatic bearing 14′ makes it possible to reduce the flow rate required for the apparatus.

Like the third embodiment shown in FIGS. 6 and 7, this embodiment can be applied to a stage when an alignment apparatus is used in a vacuum atmosphere. Measures to keep the vacuum state can be implemented by providing the labyrinth mechanisms 180 with grooves and the gas exhaust holes 181 in the vicinity of both sides of the hydrostatic bearing according to the fourth embodiment which extend from the grooves to the outside, as shown in FIG. 7, and exhausting a fluid. A compressed fluid ejected from the hydrostatic bearing is exhausted through the labyrinth mechanisms 180 and gas exhaust holes 181. The fluid does not leak to the outside (the interior of the chamber 100).

According to the above-mentioned embodiment, the internal pressure of a hydrostatic bearing can be controlled at high speed using a noncontact variable restriction, in addition to the effects of the first to third embodiments. Accordingly, a varying force (displacement) generated in the hydrostatic bearing upon movement of the structure can be cancelled, a dynamic clearance variation of the hydrostatic bearing can be reduced to substantially zero, and the restriction resistance can be changed in a noncontact manner. Thus, dust due to abrasion of a driving unit can be prevented. This embodiment is suitable for use in a clean environment.

[Exposure Apparatus]

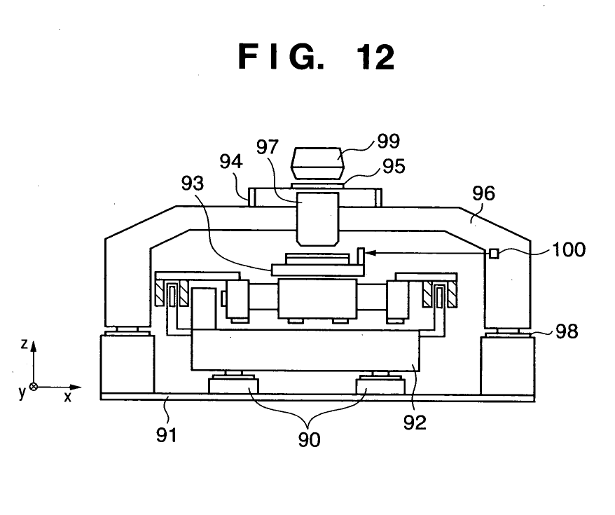

FIG. 12 is a view showing an exposure apparatus on which an alignment apparatus is mounted according to this embodiment. A stage surface plate 92 is held on a floor or basement 91 through a mount 90. A wafer stage 93 which holds a substrate such as a wafer and can move on the X-Y plane perpendicular to the optical axis of a projection optical system 97 is mounted on the center stage. The position and posture of the wafer stage 93 are measured by a laser interferometer 100.

A reticle stage 95 which holds a reticle (original) bearing a circuit pattern such that the reticle can move on the X-Y plane is held on a lens barrel surface plate 96 through the reticle stage surface plate 94. The reticle stage surface plate 94 is held on the floor/basement 91 through a damper 98. An illumination optical system 99 which illuminates the reticle with illumination light is provided to transfer part of a drawing pattern of the illuminated reticle onto the wafer through the projection optical system 97.

In the above-mentioned arrangement, the wafer stage 93 and reticle stage 95 align the substrate, original, or both of them and performs projection exposure.

[Device Manufacturing Method]

A device manufacturing method using the above-mentioned semiconductor manufacturing apparatus will be described.

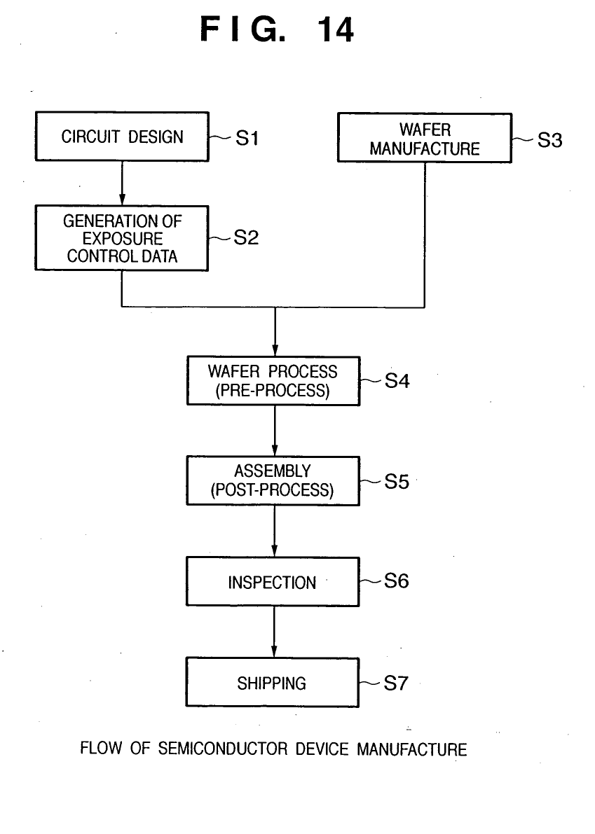

FIG. 14 shows a flowchart of an entire manufacturing process of a microdevice (e.g., a semiconductor chip such as an IC or LSI, a liquid crystal panel, a CCD, a thin-film magnetic head, or a micromachine). In step S1 (circuit design), a semiconductor device circuit is designed. In step S2 (exposure control data creation), exposure control data for an exposure apparatus is created on the basis of the designed circuit pattern. In step S3 (wafer manufacture)., a wafer is manufactured by using a material such as silicon. In step S4 (wafer process) called a preprocess, an actual circuit is formed on the wafer by lithography using the wafer and the exposure apparatus, into which the prepared exposure control data is entered mask. Step S5 (assembly) called a. post-process is the step of forming a semiconductor chip by using the wafer formed in step S4, and includes an assembly process (dicing and bonding) and packaging process (chip encapsulation). In step S6 (inspection), the semiconductor device manufactured in step S5 undergoes inspections such as an operation confirmation test and durability test. After these steps, the semiconductor device is completed and shipped (step S7).

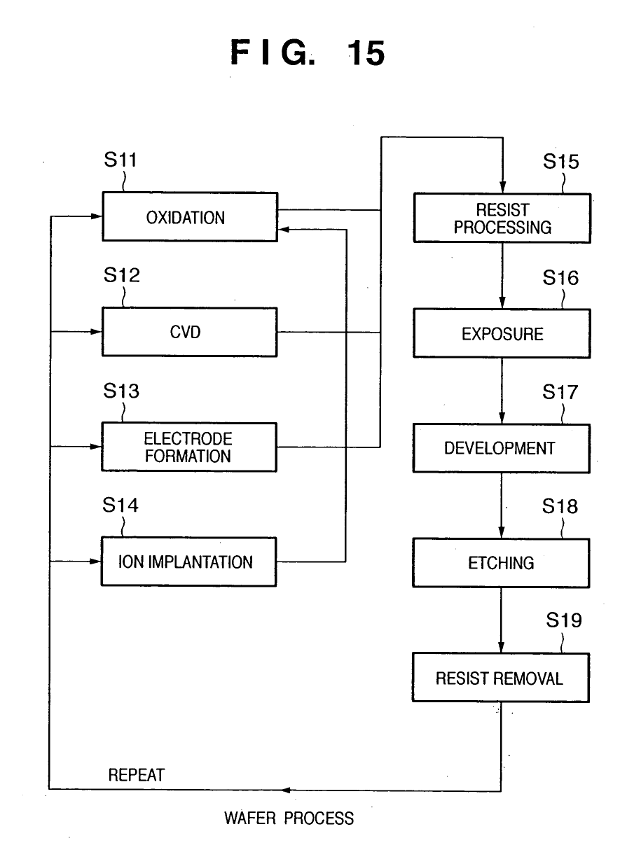

FIG. 15 shows the detailed flowchart of the above-mentioned wafer process of step S4. In step S11 (oxidation), the wafer surface is oxidized. In step S12 (CVD), an insulating film is formed on the wafer surface. In step S13 (electrode formation), an electrode is formed on the wafer by vapor deposition. In step S14 (ion implantation), ions are implanted in the wafer. In step S15 (resist processing), a photosensitive agent is applied to the wafer. In step S16 (exposure), the circuit pattern is printed onto the wafer by exposure using the above-mentioned exposure apparatus. In step S17 (development), the exposed wafer is developed. In step S18 (etching), the resist is etched except for the developed resist image. In step S19 (resist removal), an unnecessary resist after etching is removed. These steps are repeated to form multiple circuit patterns on the wafer.

Note that the above-mentioned alignment apparatus is suitable for a device which moves and aligns an object in a vacuum atmosphere, such as a measurement instrument, processing machine, or the like, in addition to an exposure apparatus.

The present invention is not limited to the above embodiments and various changes and modifications can be made within the spirit and scope of the present invention. Therefore, to apprise the public of the scope of the present invention the following claims are made.

1. An alignment apparatus comprising:
bearing means for levitating a structure by a fluid having a predetermined pressure;
control means for controlling the pressure of the fluid for supporting the structure; and
driving means for moving and aligning the structure to a target position,
wherein said control means controls the pressure of the fluid so as to cancel any displacement generated in said bearing means upon movement of the structure.

2. The apparatus according to claim 1, wherein said bearing means comprises first and second bearing means juxtaposed to each other, and said control means controls the pressure of the fluid so as to cancel any displacement generated in the second bearing means upon movement of the structure.

3. The apparatus according to claim 1, wherein said control means comprises restriction means for giving a resistance to a flow of the fluid and making variable the pressure of the fluid ejected from said bearing means.

4. The apparatus according to claim 1, wherein the restriction means comprises a valve that restricts an inlet of a hole through which the fluid passes, and said control means changes a channel area of the fluid by controlling a position of the valve and controls the pressure of the fluid.

5. The apparatus according to claim 1, wherein the restriction means comprises a shutter that restricts in a noncontact manner an inlet of a hole through which the fluid passes, and said control means changes a restriction amount of the fluid by controlling a position of the shutter and controls the pressure of the fluid.

6. The apparatus according to claim 5, wherein a bimorph actuator is used as a driving source of the shutter.

7. The apparatus according to claim 5, wherein an actuator which has an electromagnet is used as a driving source of the shutter.

8. The apparatus according to claim 5, wherein a supermagnetostrictor actuator is used as a driving source of the shutter.

9. The apparatus according to claim 5, wherein the shutter comprises means for amplifying a displacement of the shutter.

10. The apparatus according to claim 1, wherein said driving means moves the structure with a predetermined driving force.

11. The apparatus according to claim 10, wherein the predetermined driving force is feed-forwarded to said control means.

12. The apparatus according to claim 1, wherein said bearing means supports the structure on a surface substantially perpendicular to a moving direction of the structure.

13. The apparatus according to claim 2, wherein said control means reduces to substantially zero the pressure of the fluid for the second bearing means if no displacement is generated.

14. The apparatus according to claim 1, wherein
the alignment apparatus is arranged in a chamber whose interior is kept in a vacuum atmosphere, and
the alignment apparatus further comprises exhausting means for exhausting the fluid so as to prevent the fluid ejected from said bearing means from flowing into the chamber.

15. An exposure apparatus which comprises an alignment apparatus as defined in claim 1 and aligns at least one of a substrate and original by the alignment apparatus.

16. A processing apparatus which comprises an alignment apparatus as defined in claim 1 and machines an object by the alignment apparatus.

17. A device manufacturing method comprising a step of performing exposure using an exposure apparatus as defined in claim 15.

18. A hydrostatic bearing which neutrally levitates a structure by a fluid having a predetermined pressure and axially supports the structure in a noncontact manner, comprising:
variable means for making variable the pressure of the fluid for axially supporting the structure; and
control means for controlling the pressure of the fluid by said variable means.
